(19) United States
(12) Patent Application Publication
(10) Pub. No.: US 2008/0191957 A1
(43) Pub. Date: Aug. 14, 2008

(54) U shape three dimensional multi-frequency antenna

(76) Inventor: Pao-Sui Chang, Taoyan Hsien (TW)

Correspondence Address: PAO-SUI CHANG, 235 Chung-Ho, Box 8-24, Taipei, omitted

(21) Appl. No.: 11/704,836

(22) Filed: Feb. 9, 2007

(51) Int. Cl. H01Q 1/48

(52) U.S. Cl. 343/845

(57) ABSTRACT

A U shape three dimensional multi-frequency antenna, comprises a first radiation body having an L shape; a second radiation body being connected to the first radiation body; one end of the second radiation body being vertically connected to the first radiation body; a connecting portion connected to the second radiation body at one end thereof as an integral body; a connection of the connecting portion and the second radiation body being formed as a signal feeding point; a signal feeding wire being connected to the signal feeding point at one end thereof; another end of the signal feeding wire serving for being installed with an antenna receiver; and a grounding path connected to another end of the connecting portion; a potential of the grounding path being identical to the antennal receiver.

### FIELD OF THE INVENTION

The present invention relates to antennas, and particularly to a U shape three dimensional multi-frequency antenna, wherein the U shape three dimensional multi-frequency antenna is impedance-matched for

$$\frac{λ}{4}$$

so that the bandwidth of the antenna is enlarged and the signal feed wire receives signals from an antenna, the antenna has a higher gain.

### BACKGROUND OF THE INVENTION

General dipole antennas have short radiation elements and thus the bandwidth and gain thereof is not preferred. To have preferred bandwidth and gain, a plurality of dipole antennas are serially connected as an antenna array, as the generally known 2×2 or 4×4 or more array antenna. As a result, the substrate of the antenna is enlarged so that the cost is increased.

Moreover, on one prior art, a two frequency band antenna has an inverse F shape for receiving antennas in two frequency bands. The antenna has a first plane conduction element and a second plane conduction element. The former has an L shape and the later has a rectangular structure and is vertical to the former one and is connected to the former one to have a connection point.

Although the dipole antenna has the first plane conduction element and the second plane conduction element for adjusting bandwidth, impedance matching and gain, the size of the area of the second plane conduction element will affect the gain of the antenna. If it is desired to have a higher bandwidth, the area of the substrate will be enlarged. However, this can not be achieved due to the structure confinement. Moreover, when the area of the second plane conduction element is too large, the connection to the first place conduction element will break. Further, this also increases the cost.

Therefore, there is an eager demand for improving the above mentioned defects.

### SUMMARY OF THE INVENTION

Accordingly, the primary object of the present invention is to provide a U shape three dimensional multi-frequency antenna, wherein the U shape three dimensional multi-frequency antenna is impedance-matched for

$$\frac{λ}{4}$$

so that the bandwidth of the antenna is enlarged and the when the signal feed wire receives signals from an antenna, the antenna has a higher gain.

To achieve above objects, the present invention provides a U shape three dimensional multi-frequency antenna, which comprises a first radiation body having an L shape; a second radiation body being connected to the first radiation body; one end of the second radiation body being vertically connected to the first radiation body; a connecting portion connected to the second radiation body at one end thereof as an integral body; a connection of the connecting portion and the second radiation body being formed as a signal feeding point; a signal feeding wire being connected to the signal feeding point at one end thereof; another end of the signal feeding wire serving for being installed with an antenna receiver; and a grounding path connected to another end of the connecting portion; a potential of the grounding path being identical to the antennal receiver. The first radiation body, second radiation body and connecting portion are formed as a U shape. The first radiation body has an L shape and is a low frequency element and the second radiation body 11 is a high frequency body.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a front schematic view showing the structure components of the present invention.

FIG. 3 is an elevation schematic view showing the structure components of the present invention.

FIG. 4 shows the application of the present invention, where the present invention is applied to a notebook computer.

FIG. 5 shows the test result of the return lose of the present invention.

FIG. 6 shows the test result of the VSWR of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

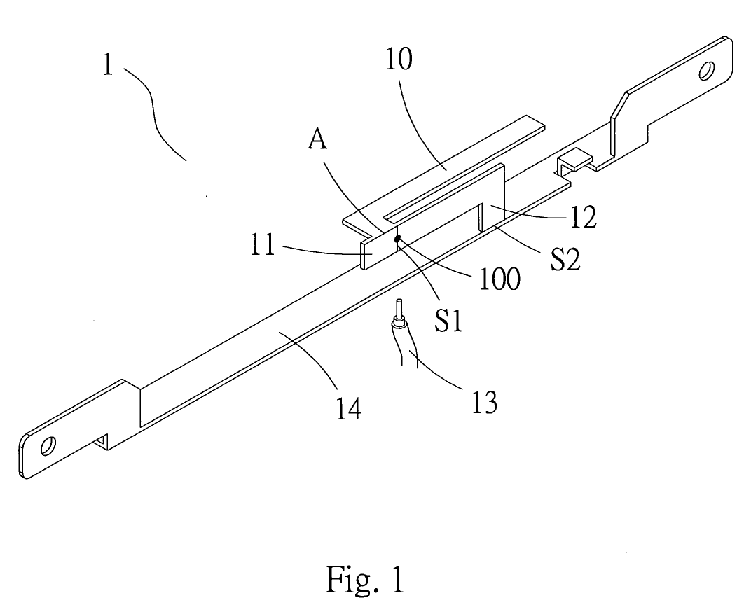

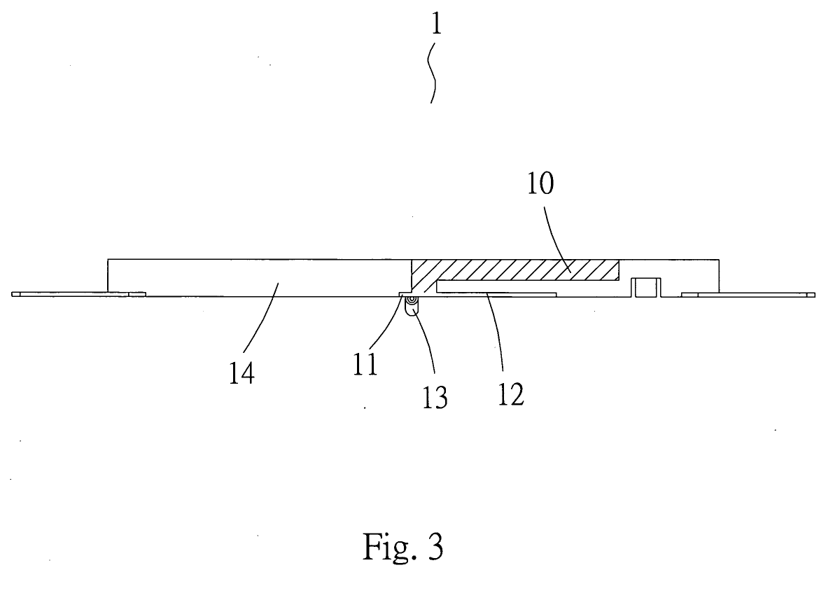

Referring to FIGS. 1, 2, and 3, the U shape three dimensional multi-frequency antenna of the present invention is illustrated. The present invention has the following elements.

A first radiation body 10 has an L shape and is a low frequency elements.

A second radiation body 11 is connected to the first radiation body. One end A of the second radiation body 11 is vertically connected to the first radiation body. The second radiation body 11 is a high frequency body.

A connecting portion 12 is connected to the second radiation body 11 at one end S1 thereof as an integral body. The connection of the connecting portion 12 and the second radiation body 11 is formed as a signal feeding point 100.

A signal feeding wire 13 is connected to the signal feeding point 100 at one end thereof. Another end of the signal feeding wire 13 is installed with an antenna receiver (not shown).

A grounding path 14 is connected to another end S2 of the connecting portion 12. The potential of the grounding path 14 is identical to the antennal receiver (not shown).

Adjusting widths of the first radiation body 10, second radiation body 11, connecting portion 12 and grounding path 14 will achieve impedance matching so as to enlarge the bandwidth of the antenna. Meanwhile, by the signal feeding point 100 at the connection of the connecting portion 12 and the second radiation body 11, reflection energy of the signals feeding to the signal feeding point 100 will reduce greatly. Thereby the signals can be transferred out of the first radiation body 10 and second radiation body 11. That is, the impedance of the antenna is matched to be 50. The size of the grounding path 14 will affect the radiation pattern of the antenna. The length of the connecting portion 12 will adjust the gap of the first radiation body 10 and second radiation body 11 so that after a signal is fed into the first radiation body 10 and second radiation body 11, the output phases of the first radiation body and second radiation body 11 are identical. Thereby the antenna has a high gain.

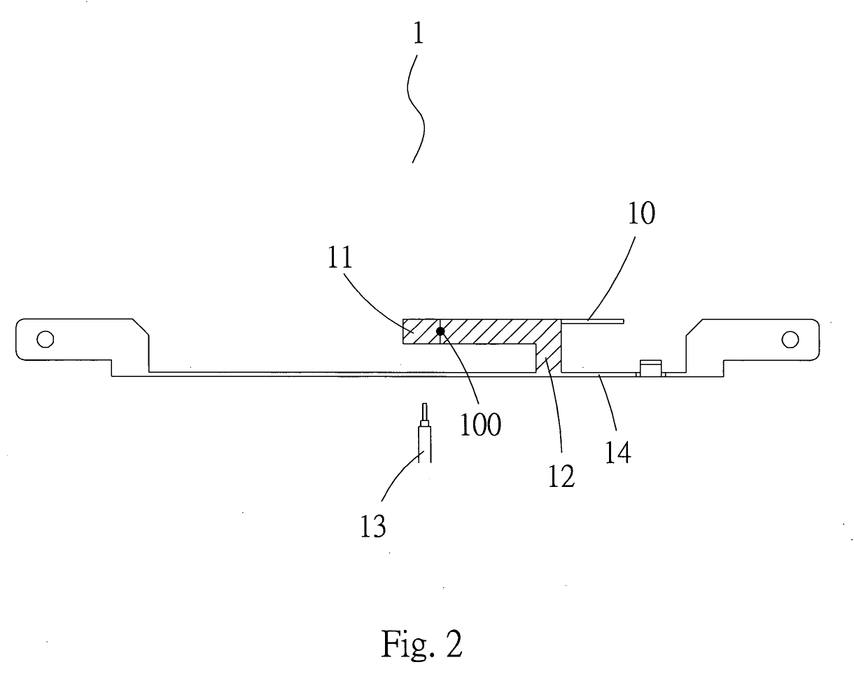

Moreover, referring to FIG. 2, in the present invention, the first radiation body 10, second radiation body 11 and connecting portion 12 are formed as a U shape so that the areas of the first radiation body 10 and second radiation body 11 can be reduced effectively so as to achieve a U shape three dimensional multi-frequency antenna with high frequency and high gain.

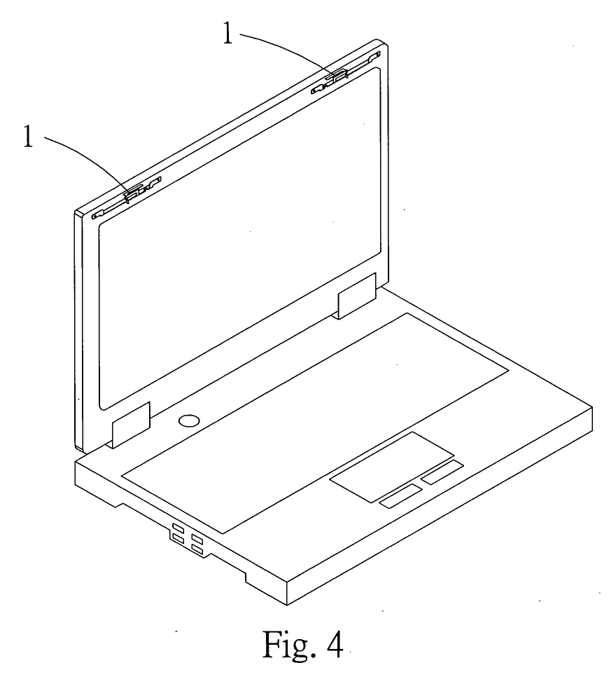

Referring to FIG. 4, it is illustrated that the present invention can be realized in a notebook.

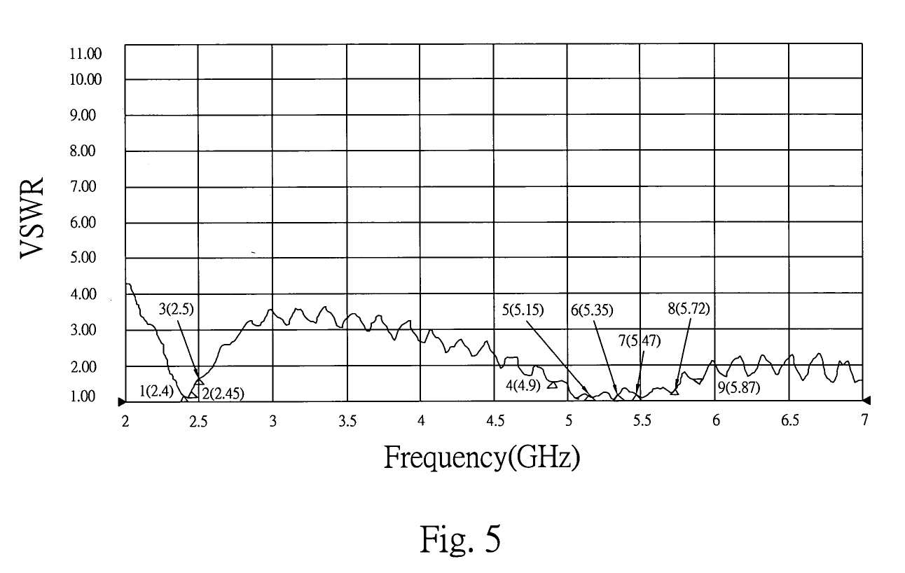

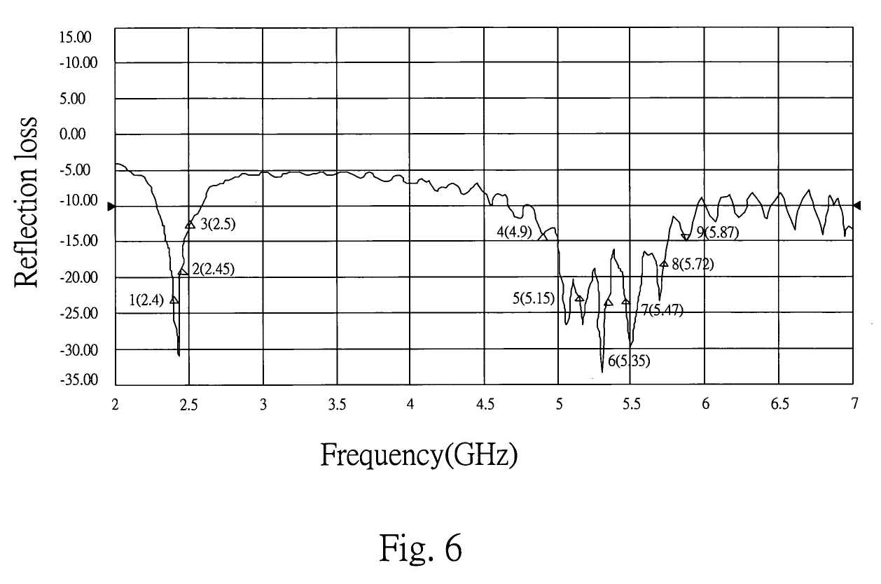

Referring to FIGS. 5 and 6, the testing result of a voltage to standing wave ratio (VSWR) and the return lose is illustrated. In FIG. 6, the simulation result of the voltage to standing wave ratio (VSWR) of the present invention is illustrated. In the present invention, the simulation result of the return lose of the present invention is illustrated.

Advantages of the present invention will be described herein. The present invention has better frequency bandwidth and gain. Furthermore, the present invention has low profile and is light. Moreover, the present invention has small volume for using with various electronic devices.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A U shape three dimensional multi-frequency antenna, comprising:
a first radiation body having an L shape;
a second radiation body being connected to the first radiation body; one end of the second radiation body being vertically connected to the first radiation body;
a connecting portion connected to the second radiation body at one end thereof as an integral body; a connection of the connecting portion and the second radiation body being formed as a signal feeding point;
a signal feeding wire being connected to the signal feeding point at one end thereof; another end of the signal feeding wire serving for being installed with an antenna receiver;
a grounding path connected to another end of the connecting portion; a potential of the grounding path being identical to the antennal receiver.

2. The U shape three dimensional multi-frequency antenna as claimed in claim 1, wherein the first radiation body, second radiation body and connecting portion are formed as a U shape.

3. The U shape three dimensional multi-frequency antenna as claimed in claim 1, wherein the first radiation body has an L shape and is a low frequency elements.

4. The U shape three dimensional multi-frequency antenna as claimed in claim 1, wherein the second radiation body is a high frequency body.
